(19) United States
(12) Patent Application Publication
(10) Pub. No.: US 2005/0244239 A1
(43) Pub. Date: Nov. 3, 2005

(54) Method and apparatus for machining a surgical implant

(76) Inventor: Lawrence A. Shimp, Morganville, NJ (US)

Correspondence Address: DILWORTH & BARRESE, LLP, 333 EARLE OVINGTON BLVD., UNIONDALE, NY, 11553, US

(21) Appl. No.: 10/516,159

(22) PCT Filed: May 30, 2003
(86) PCT No.: PCT/US03/16968

§ 371 Date: Jun. 30, 2005

Related U.S. Application Data
(60) Provisional application No. 60/384,374, filed on May 30, 2002.

(51) Int. Cl. B23C 1/00

(52) U.S. Cl. 409/132

(57) ABSTRACT

A method is provided for machining a customized surgical implant in the operating room provided. Apparatus and a kit for carrying out the method are also provided.

### CROSS REFERENCE TO RELATED APPLICATIONS

This application claims the benefit under 35 U.S.C. § 119(e) of earlier filed and copending U.S. Provisional Application No. 60/384,374, filed May 30, 2002, the contents of which are incorporated by reference herein.

### BACKGROUND OF THE INVENTION

1. Field of the Invention

The present disclosure relates generally to a method for machining a customized surgical implant in the operating room and, more particularly, to a method for machining a custom implant from a bone blank which can include unique individualized keying features for retention in a machining apparatus.

The present disclosure also relates to a machining apparatus for machining customized surgical implants and kits for producing said implants.

2. Description of the Related Art

Currently, bone based bio-implants are either entirely cut and formed at the operating site by a surgeon from a source of allograft (or in the alternative autograft) bone or are supplied by a manufacturer as a fully machined bio-implant. In general, the fully machined bio-implant is able to have a more sophisticated design in that the fully machined bio-implant is designed to be used with a specific surgical instrument and is formed with certain features (i.e., locating grooves, etc.) which are difficult or even impossible to form on-site by a surgeon using hand-held cutting tools. While bio-implants formed on-site lack the sophisticated design features of the fully machined bio-implants, the on-site formed bio-implants have the advantage of being more accurately shaped to match the specific surgical site.

The turn around time for custom bio-implants based on allograft bone is unacceptably long, generally on the order of several weeks to even a month or more. The long turn around time for such custom bio-implants is due to many factors including the need for an aseptic process and terminal sterilization, the need to locate a properly sized piece of bone stock, conflicts and back logs in the production schedule and the need to carry out proper sterility tests.

Therefore, the need exists for a method which will provide the surgeon with a method for customizing and modifying bio-implants intra-operatively and for a method which eliminates the waiting time for making a custom machined bio-implant. In particular, the need exists to provide the surgeon with a cutting machine and apparatus that will provide the surgeon with the means necessary to customize and modify pre-machined bio-implants for a specific surgical site while still retaining most or all of the implant features.

### SUMMARY OF THE INVENTION

The present invention is directed to a method for machining a surgical implant which comprises:
a) providing a bone blank having an instrument interface;
b) positioning the bone blank in a clamping device, the clamping device including a jig having a bone-supporting surface for supporting the bone blank, and the clamping device further including an abutment surface, wherein the bone blank is mounted on the bone-supporting surface of the jig and the instrument face of the bone blank is positioned in contact with the abutment surface of the clamping device;
c) relatively moving a first load bearing surface of the bone blank and a machine tool into machining contact with each other; and,
d) machining at least a portion of the first load bearing surface of the bone blank.

In one embodiment of the invention, a milling bit produces serrations on the exposed surface of the bone blank, which can then be repositioned, for example, by inverting the bone blank in the clamping device to machine the opposite side of the bone blank.

In another embodiment of the present invention, the abutment surface of the clamping device possesses a second keying element configured and dimensioned to engage the first keying element of the bone blank.

The present invention also includes a milling apparatus for machining a surgical implant and a kit containing, in combination, at least one bone blank and one or more jigs, the jigs being individually receivable into a clamping device.

The expression “bone blank” as used herein refers to the bone and any other biocompatible components utilized as the starting material for the bio-implant of the present invention. The bone blank can be machined in the operating room and a customized surgical implant is thus produced. In one embodiment, the bone blank has already been pre-machined to have certain features. Preferably, the bone blank possesses an instrument interface, which is adapted for cooperation with surgical implantation instruments. In one embodiment, the instrument interface of the bone blank possesses a keying element configured and dimensioned to engage a second keying element present on a clamping device of a machining apparatus utilized to form the bio-implant.

The term “bone” as used herein includes bone for use in a bone blank recovered from any source, including animal and human, that is suitable for implantation into a human. Such bone includes any portion thereof, including cut pieces of bone, bone particles, bone powders and mixtures of bone with other substances known in the art including binders, fillers, plasticizers, wetting agents, surface active agents, biostatic/biocidal agents, bioactive agents, reinforcing components, polymers, and the like. Such bone can be demineralized or non-demineralized.

The term “particle” as applied to the bone component of a bone blank includes bone pieces of all shapes, sizes, thicknesses and configurations such as fibers, threads, narrow strips, thin sheets, chips, shards, powders, etc., that posses regular, irregular or random geometries. It should be understood that some variation in dimension may occur in the production of bone particles, and bone particles demonstrating considerable variability in dimensions and/or size can be used and are within the scope of this invention. Bone particles that are useful herein can be homogeneous and/or heterogeneous and can include mixtures of human, xenogenic and/or transgenic material.

The term “human” as utilized herein in reference to suitable sources of bone refers to autograft bone which is taken from at least one site in the graftee and implanted in another site of the graftee as well as allograft bone which is human bone taken from a donor other than the graftee.

The term “autograft” as utilized herein refers to tissue that is obtained from the intended recipient of the implant.

The term “allograft” as utilized herein refers to tissue, which may be processed to remove cells and/or other components, intended for implantation that is taken from a different member of the same species as the intended recipient. Thus the term “allograft” includes bone from which substantially all cellular matter has been removed (processed acellular bone) as well as cell-containing bone.

The terms “xenogenic” or “xenograft” as utilized herein refers to material intended for implantation obtained from a donor source of a different species than the intended recipient. For example, when the implant is intended for use in an animal such as a horse (equine), xenogenic tissue of, e.g., bovine, porcine, caprine, etc., origin may be suitable.

The term “transgenic” as utilized herein refers to tissue intended for implantation that is obtained from an organism that has been genetically modified to contain within its genome certain genetic sequences obtained from the genome of a different species.

The expression “monolithic bone” as utilized herein refers to relatively large pieces of human or animal bone, i.e., autograft, allograft or xenograft, that are of such size as to be capable of withstanding the sort of mechanical loads to which functioning bone is characteristically subjected. Monolithic bone is to be distinguished from particles, filaments, threads, etc. as disclosed in U.S. Pat. Nos. 5,073,373, 5,314,476 and 5,507,813. It is further to be understood that the expression “monolithic bone” can refer to non-demineralized bone and to bone that has been partially demineralized. The monolithic bone utilized in a bone blank can be provided as a single integral piece of bone or as a piece of bone permanently assembled from a number of smaller bone elements, e.g., as disclosed and claimed in U.S. Pat. No. 5,899,939, the contents of which are incorporated herein by reference. Although monolithic bone can contain factors which are osteogenic, monolithic bone can also contain additional materials, e.g., as disclosed in U.S. Pat. No. 5,290,558, the contents of which are incorporated herein by reference, which will remain with the bone and will be present at the time of implantation. As used herein, “monolithic bone” is understood to have a surface area of at least 1 square centimeter.

The terms “composite” and “aggregate” are used interchangeably herein and refer to a mixture of bone particles and other materials and/or components which can be used in preparing a bone blank.

The terms “whole” and “non-demineralized” are used interchangeably herein and refer to bone that contains its full, or original, mineral content. Non-demineralized bone provides strength to the osteoimplant and allows it to initially support a load.

The term “demineralized” as utilized herein refers to bone containing less than about 95% of its original mineral content and is intended to cover all bone and/or bone particles that have had some portion of their original mineral content removed by a demineralization process. Demineralized bone induces new bone formation at the site of the demineralized bone and permits adjustment of the overall mechanical properties of the osteoimplant.

The expression “fully demineralized” as utilized herein refers to bone containing less than about 8% of its original mineral context.

The expression “partially demineralized” as utilized herein refers to bone that has been demineralized to some minor extent, i.e., to an extent which reduces the original strength of the bone by no more than about 50 percent. “Partially demineralized” bone includes bone that has only had a portion of its surface demineralized. Demineralized bone induces new bone formation at the site of the demineralized bone and permits adjustment of the overall mechanical properties of the bio-implant.

The term “osteogenic” as utilized herein shall be understood as referring to the ability of an implant to enhance or accelerate the growth of new bone tissue by one or more mechanisms such as osteogenesis, osteoconduction and/or osteoinduction.

The term “osteoconductive” as utilized herein shall be understood to refer to the ability of a non-osteoinductive substance to serve as a suitable template or substrate along which bone can grow.

The term “osteoinductive” as utilized herein shall be understood to refer to the ability of a substance to recruit cells from the host that have the potential for forming new bone and repairing bone tissue. Most osteoinductive materials can stimulate the formation of ectopic bone in soft tissue.

The term “shape” as applied to the bone blank herein refers to a process to obtain a determined or regular form or configuration in contrast to an indeterminate or vague form or configuration (as in the case of a lump or other solid mass of no special form) and is characteristic of such materials as sheets, plates, disks, cores, pins, screws, tubes, teeth, bones, portions of bones, wedges, cylinders, threaded cylinders, cages, and the like. This includes forms ranging from regular geometric shapes to irregular, angled, or non-geometric shapes and combinations of features having any of these characteristics. The result of a shaping process to a bone blank is a bio-implant suitable for implantation in a mammal. The term “shape” as used herein also refers to the application of a pattern or texture, e.g., serrations, to the surface of a bone blank to thus form a bio-implant.

The terms “machine tool” and “machining” shall be understood to include all tools that perform at least one mechanical shaping operation brought about by removal of material from the bone blank and include such operations as milling, shaping, drilling, chamfering, beveling, texturizing, surface-patterning, etc.

The term “implantable” as utilized herein refers to a bio-implant device retaining potential for successful surgical placement within a mammal.

The expression “implantable device” and expressions of like import as utilized herein refer to any object implantable through surgical, injection, or other suitable means whose primary function is achieved either through its physical presence or mechanical properties.

The term “polymeric” as utilized herein refers to a material of natural, synthetic or semisynthetic origin that is made of large molecules featuring characteristic repeating units.

### BRIEF DESCRIPTION OF THE FIGURES

Various embodiments of the invention are described below with reference to the accompanying drawings, in which:

FIG. 1 is a schematic representation of a step of the method for preparing a bio-implant in accordance with the present disclosure;

FIG. 2 is a schematic representation of another step of the method for preparing the bio-implant in accordance with the present disclosure;

FIG. 3 is a perspective view of an illustrative bio-implant produced after having gone through the steps shown in FIGS. 1 and 2;

FIG. 4 is a perspective view of an illustrative apparatus for performing the method in accordance with the present disclosure; and

FIG. 5 is a perspective view of an alternative illustrative apparatus for performing the method in accordance with the present disclosure.

### DETAILED DESCRIPTION OF THE INVENTION

The present invention is directed to methods and apparatus for machining a bone blank intra-operatively in the operating room to produce a customized surgical bio-implant.

Bone blanks which can be machined in accordance with the present invention include those made of monolithic bone, or bone composites made from pieces of bone, bone particles, etc. The bone component of the bone blanks can be mineralized, demineralized, partially demineralized and combinations thereof. Such composites are disclosed, for example, in U.S. Pat. Nos. 6,478,825, 6,440,444, 6,294,187, 6,294,041 and 6,123,731, the contents of each of which are incorporated by reference herein. The bone blank, especially where it is made of a composite or aggregate of bone particles, can be combined with one or more biocompatible components such as wetting agents, biocompatible binders, fillers, fibers, plasticizers, biostatic/biocidal agents, surface active agents, bioactive agents, and the like, prior to, during, or after forming the bone blank. One or-more of such components can be combined with the bone by any suitable means, e.g., by soaking or immersing the bone in a solution or dispersion of the desired component, and the like. Where the bone blank is made of bone particles, one or more of such components can also be combined with the bone particles by physically admixing the bone particles and the desired component.

Suitable wetting agents include biocompatible liquids such as water, organic protic solvents, aqueous solutions such as physiological saline, concentrated saline solutions, sugar solutions, ionic solutions of any kind, liquid polyhydroxy compounds such as glycerol, glycerol esters and mixtures thereof. Where the bone blank includes bone particles, the use of wetting agents in general is preferred in the practice of the present invention as they improve handling of bone particles. When employed, wetting agents typically represent from about 20 to about 80 weight percent of the bone forming the bone blank. (In all instances herein where the bone component of the bone blank is made of a composite or aggregate of bone particles, it is to be understood that the weight percent of any additional component of the bone blank is calculated prior to compression of the composite forming the bone blank.) Certain wetting agents such as water can be advantageously removed from the bio-implant, e.g., by heating and lyophilizing the bio-implant.

The use of a biocompatible binder as a biocompatible component is particularly preferred where the bone blank includes a bone composite or aggregate. A biocompatible binder acts as a matrix which binds the bone particles, thus providing coherency in a fluid environment and also improving the mechanical strength of the resulting implant.

Suitable biocompatible binders include biological adhesives such as fibrin glue, fibrinogen, thrombin, mussel adhesive protein, silk, elastin, collagen, casein, gelatin, albumin, keratin, chitin or chitosan; cyanoacrylates; epoxy-based compounds; dental resin sealants; bioactive glass ceramics (such as apatite-wollastonite), dental resin cements; glass ionomer cements (such as Ionocap® and Ionocem® available from Ionos Medizinische Produkte GmbH, Greisberg, Germany); gelatin-resorcinol-formaldehyde glues; collagen-based glues; bioabsorbable polymers such as starches, polylactic acid, polyglycolic acid, polylactic-co-glycolic acid, polydioxanone, polycaprolactone, polycarbonates, polyorthoesters, polyamino acids, polyanhydrides, polyhydroxybutyrate, polyhydroxyvalyrate, poly (propylene glycol-co-fumaric acid), tyrosine-based polycarbonates, pharmaceutical tablet binders (such as Eudragit® binders available from Hüls America, Inc.), polyvinylpyrrolidone, cellulosics such as cellulose, ethyl cellulose, micro-crystalline cellulose and blends thereof; starches; ethylenevinyl alcohols; polycyanoacrylates; polyphosphazenes; nonbioabsorbable polymers such as polyacrylate, polymethyl methacrylate, polytetrafluoroethylene, polyurethane and polyamide; etc. Preferred binders are polyhydroxybutyrate, polyhydroxyvalerate and tyrosine-based polycarbonates. When employed, binders typically represent from about 5 to about 70 weight percent of the bone composite forming the bone blank.

Suitable fillers include graphite, pyrolytic carbon, bioceramics, bone powder, demineralized bone powder, anorganic bone (i.e., bone mineral only, with the organic constituents removed), dentin, tooth enamel, aragonite, calcite, nacre, amorphous calcium phosphate, hydroxyapatite, tricalcium phosphate, Bioglass® and other calcium phosphate materials, calcium salts, etc. Preferred fillers are demineralized bone powder and hydroxyapatite. When employed, fillers typically represent from about 5 to about 80 weight percent of the bone particle composite forming the bone blank.

Suitable fibers include carbon fibers, collagen fibers, tendon or ligament derived fibers, keratin, cellulose, hydroxyapatite and other calcium phosphate fibers. When employed, fibers typically represent from about 5 to about 75 weight percent of the bone particle composite forming the bone blank.

Suitable plasticizers include liquid polyhydroxy compounds such as glycerol, monoacetin, diacetin, etc. Glycerol and aqueous solutions of glycerol are preferred. When employed, plasticizers typically represent from about 20 to about 80 weight percent of the bone forming the bone blank.

Suitable biostatic/biocidal agents include antibiotics such as erythromycin, bacitracin, neomycin, penicillin, polymycin B, tetracyclines, biomycin, chloromycetin, streptomycins, cefazolin, ampicillin, azactam, tobramycin, clindamycin, gentamicin, povidone, sugars, mucopolysaccharides, etc. Preferred biostatic/biocidal agents are antibiotics. When employed, biostatic/biocidal agents typically represent from about 10 to about 95 weight percent of the bone forming the bone blank.

Suitable surface active agents include the biocompatible nonionic, cationic, anionic and amphoteric surfactants. Preferred surface active agents are the nonionic surfactants. When employed, surface active agents typically represent from about 1 to about 80 weight percent of the bone forming the bone blank

Any of a variety of bioactive substances can be incorporated in, or associated with, the bone blank. Thus, one or more bioactive substances can be combined with the bone blank, or where the bone blank is a composite of bone particles, the particles themselves, by soaking or immersing the bone in a solution or dispersion of the desired bioactive substance(s). Bioactive substances include physiologically or pharmacologically active substances that act locally or systemically in the host.

Bioactive substances which can be readily combined with the bone of the bone blank include, e.g., collagen, insoluble collagen derivatives, etc., and soluble solids and/or liquids dissolved therein; antiviricides, particularly those effective against HIV and hepatitis; antimicrobials and/or antibiotics such as erythromycin, bacitracin, neomycin, penicillin, polymycin B, tetracyclines, biomycin, chloromycetin, streptomycins, cefazolin, ampicillin, azactam, tobramycin, clindamycin and gentamicin, etc.; biocidal/biostatic sugars such as dextran, glucose, etc.; amino acids; peptides; vitamins; inorganic elements; co-factors for protein synthesis; hormones; endocrine tissue or tissue fragments; synthesizers; enzymes such as collagenase, peptidases, oxidases, etc.; polymer cell scaffolds with parenchymal cells; angiogenic agents and polymeric carriers containing such agents; collagen lattices; antigenic agents; cytoskeletal agents; cartilage fragments; living cells such as chondrocytes, bone marrow cells, mesenchymal stem cells, natural extracts, genetically engineered living cells or otherwise modified living cells; DNA delivered by plasmid or viral vectors; tissue transplants; demineralized bone powder; autogenous tissues such as blood, serum, soft tissue, bone marrow, etc.; bioadhesives; bone morphogenic proteins (BMPs); osteoinductive factor; fibronectin (FN); endothelial cell growth factor (ECGF); cementum attachment extracts (CAE); ketanserin; human growth hormone (HGH); animal growth hormones; epidermal growth factor (EGF); interleukin-1 (IL-1); human alpha thrombin; transforming growth factor (TGF-beta); insulin-like growth factor (IGF-1); platelet derived growth factors (PDGF); fibroblast growth factors (FGF, bFGF, etc.); periodontal ligament chemotactic factor (PDLGF); somatotropin; bone digesters; antitumor agents; immuno-suppressants; permeation enhancers, e.g., fatty acid esters such as laureate, myristate and stearate monoesters of polyethylene glycol, enamine derivatives, alpha-keto aldehydes, etc.; and nucleic acids. Preferred bioactive substances include bone morphogenic proteins and DNA delivered by plasmid or viral vector. When employed, bioactive substances typically represent from about 0.1 to about 20 weight percent of the bone forming the bone blank.

It will be understood by those skilled in the art that the foregoing biocompatible components are not intended to be exhaustive and that other biocompatible components can be added to the bone blank or admixed with bone particles where the bone blank is made of a bone composite.

Where the bone blank comprises a bone composite, after production of the bone composite the composite is subjected to a compressive force of at least about 1,000 psi to produce the bone blank of this invention. Typically, compressive forces of from about 2,500 to about 60,000 psi can be employed with particularly good effect, with compressive forces of from about 2,500 to about 20,000 psi presently being preferred. The compression step will typically be conducted for a period of time ranging from about 0.1 to about 180 hours, preferably from about 4 to about 72 hours. The resulting bone blank possesses a bulk density (measured by dividing the weight of the bone blank by its volume) of at least about 0.7 g/cm³, preferably at least about 1.0 g/cm³. After being immersed in physiological saline for 12-24 hours, the bone blank of this invention possesses a wet compressive strength of at least about 3 MPa. Typically, the wet compressive strength of the bone blank substantially exceeds 3 MPa In most cases (and especially where a predominant amount of nondemineralized elongate bone particles are utilized in the fabrication of the bone composite utilized in the bone blank), the inventors have found that wet compressive strength normally exceeds about 15 MPa and typically ranges from about 15 to about 100 MPA.

To effect compression of the composite, the composite can be placed in a mold possessing any suitable or desired shape or configuration and compressed in a press, e.g., a Carver® manual press.

In addition, the bone in the bone blanks, which includes any bone particles therein, can be mineralized, demineralized, partially demineralized and combinations thereof.

Methods for demineralizing bone, including the surface area of sections of bone, are known. Demineralization procedures remove the inorganic mineral component of bone by employing acid solutions. Such procedures are well known in the art, see for example, Reddi et al., Proceeding of the National Academy of Sciences of the United States of America 69, pp. 1601-1605 (1972), incorporated herein by reference. The strength of the acid solution, the shape and size of the bone and the duration of the demineralization procedure will determine the extent of demineralization. Control of these variables to effect the desired extent of demineralization is well within the purview of those skilled in the art.

Demineralizing bone, using for example, a controlled acid treatment, increases the osteoinductive characteristics of the implant. Demineralization also provides the implant with a degree of flexibility. However, removal of the mineral components of bone significantly reduces mechanical strength of bone tissue. See, Lewandrowski et al., Clinical Ortho. Rel. Res., 317, pp. 254-262 (1995). Thus, demineralization sacrifices some of the load-bearing capacity of mineralized cortical bone and as such is not suitable for all implant designs. Demineralization of the bone will also ordinarily result in bone of slightly smaller dimensions. Such changes of dimension can make it difficult for a configured piece to mechanically engage with surgical instruments, other implants, or the prepared surgical site.

In a preferred demineralization procedure, the bone to be utilized in the bone blank for forming into a bio-implant is subjected to an acid demineralization step followed by a defatting/disinfecting step. The bone is immersed in acid over time to effect demineralization. Acids that can be employed in this step include inorganic acids such as hydrochloric acid as well as organic acids such as formic acid, acetic acid, peracetic acid, citric acid, propionic acid, etc. The depth of demineralization into the bone surface can be controlled by adjusting the treatment time, temperature of the demineralizing solution, concentration of the demineralizing solution, and agitation intensity during treatment.

In the defatting/disinfecting step, the demineralized bone is rinsed with sterile water and/or buffered solution(s) to remove residual amounts of acid and thereby raise the pH. A preferred defatting/disinfectant solution is an aqueous solution of ethanol, the ethanol being a good solvent for lipids and the water being a good hydrophilic carrier to enable the solution to penetrate more deeply into the bone. The aqueous ethanol solution also disinfects the bone by killing vegetative microorganisms and viruses. Ordinarily, at least about 10 to 40 percent by weight of water (i.e., about 60 to 90 weight percent of defatting agent such as alcohol) should be present in the defatting/disinfecting solution to produce optimal lipid removal and disinfection within the shortest period of time. The preferred concentration range of the defatting solution is from about 60 to about 85 weight percent alcohol and most preferably about 70 weight percent alcohol.

In some embodiments of the present invention, the bone utilized in the bone blanks can be only partially demineralized and/or surface demineralized.

Preferred embodiments of the presently disclosed method for machining a surgical bio-implant 100 will now be described in detail with reference to the accompanying drawings, in which like reference numerals designate identical or corresponding elements in each of the several views.

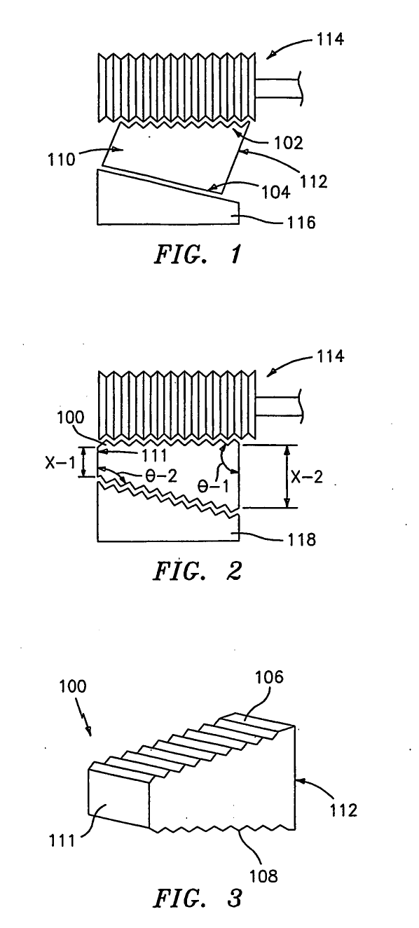

As seen in FIGS. 1-3, by way of example only, for bio-implants 100 (e.g., spinal fusion implants) having an upper weight bearing surface 102 and a lower weight bearing surface 104, the method according to the present disclosure enables a surgeon or technician to (1) intra-operatively change the relative angles θ-1 and θ-2 (see FIG. 2), respectively, of the upper and lower weight bearing surfaces 102 and 104 within the bio-implant 100, (2) to change the overall separation X-1 and X-2 (i.e., height) (see FIG. 2) between the upper and lower weight bearing surfaces 102 and 104 at the distal face 111 and instrument face 112, respectively, of the bio-implant 100, and (3) to change the surface contours of the weight bearing surfaces of the bio-implant using a machining system which is adaptable to be located in an operating room. The resulting bio-implants 100 would include a serrated upper and lower weight bearing surface 106 and 108, respectively. The bio-implants can be demineralized on most surfaces (if desired) and can be compatible with insertion instruments and have a precisely controlled customized facial angle and height.

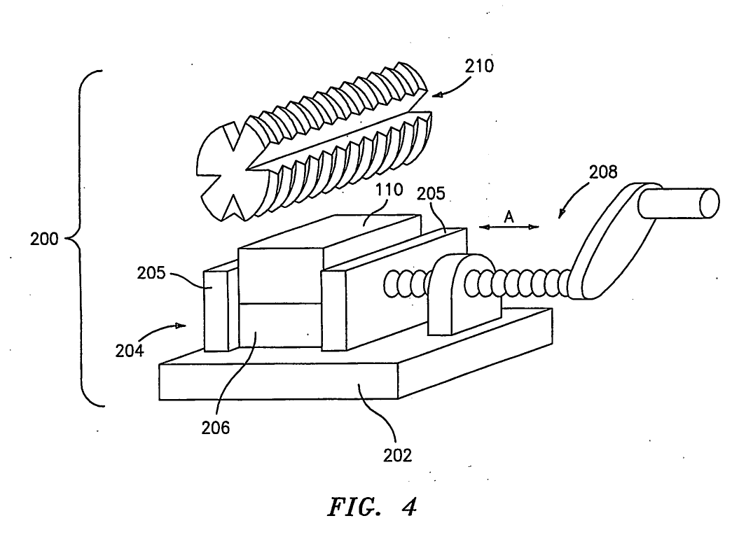

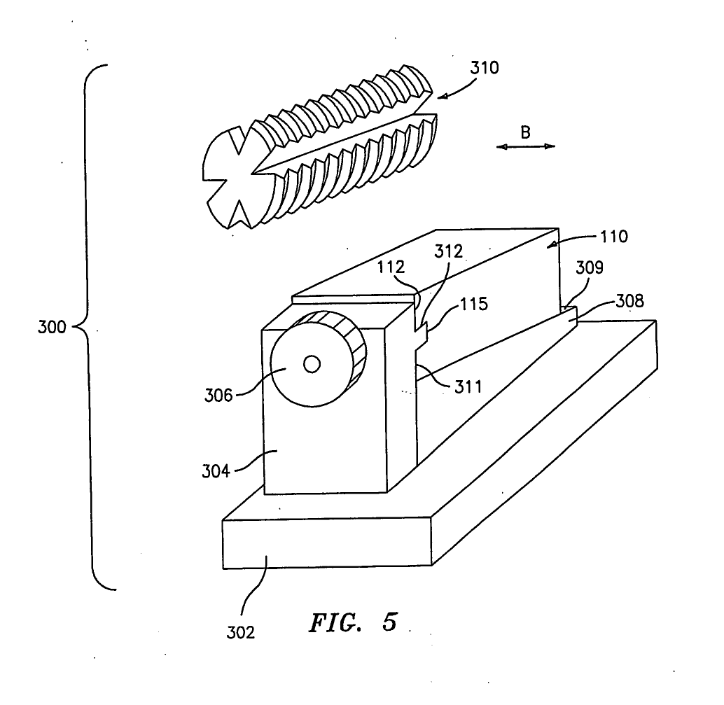

According to the present disclosure and as seen in FIGS. 1-3, the bio-implant manufacturer would supply a sterile, partially machined allograft bone blank 110 to the surgeon. The allograft bone blank 110 would have a pre-machined instrument face 112, i.e., the proximal surface of the allograft bone which is adapted for cooperation with the surgical implantation instruments, and the bone blank can also be pre-cut to various lengths and widths thereby providing a surgeon or technician with an array of allograft bone blanks 110 from which to choose for further shaping in a machining apparatus 200 (see FIGS. 4 and 5). However, the weight bearing surfaces 102 and 104 (i.e., the upper and lower surfaces) would remain un-machined.

Turning now to FIG. 4, the machining apparatus 200 includes a housing 202, a vice clamp 204 having a pair of jaws 205, the vice clamp 204 being operatively coupled to the housing 202. One of a plurality of interchangeable support jigs 206 may be disposed between jaws 205 of the vice clamp 204, and the machining apparatus includes a cranking apparatus 208 for linearly moving the vice clamp 204 through the housing 202, and a cutting tool such as rotatable milling drill bit 210 transversely aligned relative to the direction of movement of the vice clamp 204 depicted by the arrow “A”. Each support jig 206 is a wedge shaped member which includes a planar bottom surface and an inclined top surface angled in the direction of the linear axis of the drilling bit 210. Each support jig 206 (only one is shown) has a different angle of inclination and/or thickness such that a bone blank 110 placed thereon can be machined to have the desired angle of inclination and/or height. The desired angle of inclination is determined by the surgeon by examining the bio-implant site of a patient.

In operation and in accordance with the present disclosure for machining bio-implants 100, a pre-selected support jig 206 having a surface with a predetermined angle of inclination is placed between the vice clamp 204 and a new bone blank 110 is secured onto the support jig 206 by closing the jaws 205 of the vice clamp 204 thereon. The cranking means 208 is then activated in order to transversely pass the bone blank 110 across the rotating milling drill bit 210, thereby shaping a surface (i.e., an upper or lower weight bearing surface 102 or 104) of the bone blank 110 into the serrated weight bearing surface 106 or 108. Although a serrated milling bit is shown producing serrations on the weight bearing surface 106 or 108, different milling bits can be utilized to provide the bio-implant with differently shaped load bearing surfaces. In order to shape the opposite surface of the bone blank 110 and to complete the formation of the bio-implant 100 (i.e., the other of the upper or lower weight bearing surfaces), the shaped surface of the bone blank 110 is secured on the top of another selected support jig 206 between the jaws 205 of the vice clamp 204 and the bone blank 110 is once again passed across the rotating milling drill bit 210 thereby forming the other of the serrated surface 106 or 108.

Turning now to FIG. 5, a machining apparatus according to an alternative embodiment is generally shown as 300. The machining apparatus includes a housing 302 on which is operatively coupled a clamping device 304 having a cranking apparatus 306 operatively coupled thereto, one of a plurality of interchangeable support jigs 308 and a rotational milling drill bit 310 aligned transversely to a direction of movement of the clamping device 304 depicted by the arrow “B”. The clamping device 304 further includes an abutment surface 311 having a second keying element 312 configured and dimensioned for engagement and cooperation with a corresponding first keying element 115 formed on the instrument face 112 of each bone blank 110 provided by a certain manufacturer. The first and second keying elements can be correspondingly shaped convexities or concavities such as ridges, grooves or other variously shaped projections, recesses, or apertures. Once again, each support jig 308 includes a planar bottom surface and an inclined top surface angled in the direction of the linear axis of the drill bit 310. Each support jig 308 has a different angle of inclination such that a bone blank 110 placed thereon will be machined having a different angle of inclination.

As depicted in FIG. 5, in operation and in accordance with the present disclosure for machining a bio-implant 100, a pre-selected support jig 308 having a support surface 309 with a predetermined angle of inclination is placed up against the clamping device 304. The bone blank 110 is placed on the support jig 308 and positioned such that the instrument face is flush against the abutment surface 311 such that the unique first keying element 115 formed on the bone blank 110 is mated with second keying element 312 on the abutment surface 311 of the clamping device 304. In this manner, only bone blanks which have cooperating keying elements can be machined within the machining apparatus. The cranking apparatus 306 is then activated in order to transversely pass the bone blank 110 across the rotating milling drill bit 310 thereby shaping the surface (i.e., upper or lower weight bearing surface 102 or 104) of the bone blank 110 into the serrated weight bearing surface 106 or 108. In order to shape the opposite surface of the bone blank 110, the bone blank 110 is re-coupled to the clamping device 304, with the machined surface oriented downwardly on another pre-selected support jig 308. Once again, the first keying element 115 formed on the bone blank 110 must mate with the second keying element 312 of the clamping device 304 in order for the machining apparatus 300 to operate.

The keying elements can be solely compatible for cooperation with the surgical instruments to be employed for implanting as well as for cooperation with the machining apparatus, or where disposable jigs are supplied in a kit with one or more allograft bone blanks, each bone blank can cooperate solely with specific retaining means (i.e., vise clamp, clamping means, etc.) provided in the machining apparatus. The disposable jigs can be made of a plastic such as polyethylene, or other materials such as gelatins, which can be easily sterilized by radiation, but which will be destroyed or damaged by other means of sterilization such as autoclaving. The purpose is to prevent the reuse of the jigs as much as possible by making the jigs incompatible with sterilizing means that are commonly found in clinics or hospitals. The jigs can be made of any other easily radiation sterilizable material, meeting the above requirements.

The keying elements also ensure that the surgeon or technician cannot use the machining apparatus with bio-implants supplied by other manufacturers, or with allograft bone blanks which the surgeon has fashioned himself. Such keying design features can include, for example as described above, a keying system whereby, during the machining operation, the allograft bone blank is retained within the machining apparatus by keying arrangements formed on the instrument face of the allograft bone blank.

Thus, medical personnel can be provided with a packaged kit containing an assortment of interchangeable jigs of various shapes and having various inclinations and at least one bone blank, each bone blank having a keying element adapted to mate with a corresponding keying element in a clamping device of a machining apparatus. The kit can optionally include a machining apparatus with the clamping device and optionally a rotatable milling bit or other such cutting tool. The clamping device is adapted to receive an individual jig and a bone blank supported by the jig.

The machining apparatus itself is adaptable for an operating room environment. In other words, the machining apparatus can be sterilized (preferably by autoclaving) and should not emit an unacceptable amount of contamination into the operating room during use. Power sources for driving the rotating milling drill bits include, air or another compressed gas, electricity, a manual crank, a fly wheel, etc. A manual crank could be used to feed the implant under the milling bit, but other arrangements such as a compressed air cylinder, a spring, etc., can be used.

Preferably, to speed the work and ensure the highest possible precision, machining is carried out in one pass of the allograft bone blank under the rotating milling drill bit. The milling drill bit will form all of the desired features and contours onto the bone blank at once. The milling bit can be horizontal as shown in the figures, or vertical (a face mill) in order to give different finish patterns such as a concave or convex surface, a circular groove pattern, etc.

Returning now to FIGS. 1-3, the steps for machining the weight bearing surfaces 106 and 108 (see FIG. 3) of a posterior spinal bio-implant 100 by a shaped milling drill bit 114 applied to a bone blank 110 are shown (see FIGS. 1 and 2). The height and angle of the weight bearing surfaces 106 and 108 are determined by interchangeable jigs 116 on which the bio-implant 100 rests during the machining process. The angle that the bone blank-contacting surface of an interchangeable jig makes relative to the surface of drill bit 114 (or other machine tool) can be adjusted as desired and can be essentially 0° (in which case the aforesaid surfaces will be essentially parallel to each other) or at any sloped angle approaching 90°.

The interchangeable jigs 116 are pre-sterilized and can be made of polyethylene or other disposable materials and are supplied in a variety of angles in order to create the angle of inclination desired in the bio-implant 100. Alternatively, a single jig can be provided which through simple mechanical means such as adjustable screws, camming surfaces, etc., can be made to provide a range of angles and/or widths and lengths. Angular adjustment of the jig can, if desired, be made after a machining operation to readjust the angle of the bone blank to the machine tool. The dimensions of the bio-implant 100 are determined by the jigs so that no machining skill is needed by the surgeon or technician. A first interchangeable jig 116 (i.e., implant support jig) supports the bone blank 110 during the machining of the first weight bearing surface 102 (see FIG. 1) to form the first serrated weight bearing surface 106 (see FIG. 3). After the first serrated weight bearing surface 106 is machined, a second interchangeable jig 118, which can possess a bone blank support surface with an inclination different from that of the first interchangeable jig, is used to support the first serrated weight bearing surface 106 of the bio-implant 100 in order to shape the second weight bearing surface 104 to form the second serrated weight bearing surface 108 (see FIG. 2). The differences in height and angle of the two support jigs 116 and 118 determine the overall height and angle of the finished bio-implant 100.

The bone blank 110 can be held in the machine by a clamp that squeezes the sides of the bone blank, leaving the weight bearing surface 102 or 104 open for machining (see FIG. 4) or, in another embodiment, a screw from a clamping means can engage a threaded insertion instrument pilot hole and/or any other special unique instrument engagement features such as a groove (i.e., keying means 312 in FIG. 5). For additional support, the jig located under the implant can have partial sides (not shown) to aid in the prevention of lateral movement of the bone blank 110.

It is preferable to machine each surface of the bio-implant 100 in one pass using a shaped cutting bit, but it is envisioned that several passes of the cutting bit at different depths or at different directions are also possible, though with added machining complication.

It will be understood that various modifications may be made to the embodiments disclosed herein. Therefore, the above description should not be construed as limiting, but merely as exemplifications of preferred embodiments.

1. A method for machining a surgical implant which comprises:
a) providing a bone blank having an instrument face;
b) positioning the bone blank in a clamping device, the clamping device including a jig having a bone-supporting surface for supporting the bone blank, and the clamping device further including an abutment surface, wherein the bone blank is mounted on the bone-supporting surface of the jig and the instrument face of the bone blank is positioned in contact with the abutment surface of the clamping device;
c) relatively moving a first load bearing surface of the bone blank and a machine tool into machining contact with each other; and
d) matching at least a portion of the first load bearing surface of the bone blank.

2. The method of claim 1 wherein the bone blank is repositioned in the clamping device after machining step (d) to present a second load bearing surface of the bone blank, at least a portion of the second load bearing surface of the bone blank thereafter being machined.

3. The method of claim 1 wherein milling the load bearing surface of the bone blank produces serrations or protrusions thereon.

4. The method of claim 1 wherein the angle of the jig with respect to the machine tool is adjustable.

5. A method for machining a surgical implant which comprises:
a) providing a bone blank having an instrument face with a first keying element configured and dimensioned to engage a second keying element;
b) positioning the bone blank in a clamping device, the clamping device including a jig having a bone-supporting surface for supporting the bone blank, and the clamping device further including an abutment surface having a second keying element configured and dimensioned to engage the first keying element of the bone blank, wherein the bone blank is mounted on the bone-supporting surface of the jig and the instrument face of the bone blank is positioned in contact with the abutment surface of the clamping device;
c) relatively moving a first load bearing surface of the bone blank and a machine tool into machining contact with each other; and
d) machining at least a portion of a first load bearing surface of the bone blank.

6. The method of claim 5 wherein the bone blank is repositioned in the clamping device after machining step (d) to present a second load bearing surface of the bone blank, at least a portion of the second load bearing surface thereafter being machined.

7. The method of claim 5 wherein machining of a load bearing surface of the bone blank produces serrations or protrusions thereon.

8. The method of claim 1 wherein the angle of the jig with respect to the machine tool is adjustable.

9. A machining apparatus for machining a surgical implant comprising a clamping device for receiving a jig and a bone blank possessing a first keying element, the clamping device having an abutment surface with a second keying element configured and dimensioned to engage the first keying element of the bone blank.

10. The machining apparatus of claim 9 wherein the machining apparatus includes a cutting tool.

11. The machining apparatus of claim 10 wherein the cutting tool is a rotatable milling bit.

12. The machining apparatus of claim 9 wherein the machining apparatus further includes means for relatively moving the bones blank and the cutting tool into machining contact with each other.

13. A surgical kit comprising:
a) at least one bone blank for implantation into a body, the bone blank having an instrument face with a first keying element; and
b) at least one jig, the jig having a bone blank support surface with a variable angulation surface or a predetermined angle of inclination, said jig being individually receivable into a clamping device.

14. The kit of claim 1 wherein the jig is made of material that cannot be sterilized by heat or autoclaving.

15. The kit of claim 13 further including a machining apparatus.

16. The kit of claim 15 wherein the machining apparatus includes a clamping device for receiving the jig and bone blank, the clamping device having an abutment surface with a second keying element configured and dimensioned to engage the first keying element of the bone blank.

17. The kit of claim 16 wherein the machining apparatus includes a cutting tool.

18. The kit of claim 17 wherein the cutting tool is a rotatable milling bit.

19. The kit of claim 16 wherein the machining apparatus further includes means for relatively moving the bone blank and the cutting tool into machining contact with each other.

20. The kit of claim 13 wherein the bone blank comprises monolithic bone.

21. The method of claim 2 wherein milling the load bearing surface of the bone blank produces serrations thereon.
